(19) United States
(12) Patent Application Publication
(10) Pub. No.: US 2008/0207273 A1
(43) Pub. Date: Aug. 28, 2008

(54) SLIDING-TYPE MOBILE PHONE WITH A SUPPLEMENTAL DISPLAY SECREEN

(75) Inventor: Liang HUO, Beijing (CN)

Correspondence Address: Jefferson IP Law, LLP, 1730 M Street, NW, Suite 807, Washington, DC, 20036, US

(73) Assignees: SAMSUNG ELECTRONICS CO., LTD., Suwon-city (KR); BEIJING SAMSUNG TELECOM R & D CENTER, Beijing (CN)

(21) Appl. No.: 12/033,683

(22) Filed: Feb. 19, 2008

(30) Foreign Application Priority Data
Feb. 25, 2007 (CN) 200710080280.1

(51) Int. Cl. H04B 1/38

(52) U.S. Cl. 455/566

(57) ABSTRACT

A sliding-type mobile device is provided. The sliding-type mobile device includes a base, a first display screen disposed on the base, a sliding section disposed above the base and mechanically coupled to the base such that the sliding section moves relative to the base, a second display screen disposed on the sliding section, a processor for controlling operations of the mobile device, and a controller for receiving data and at least one control signal from the processor, and for transmitting the received data to one of the first display screen and the second display screen according to information in at least one control signal. In a case where a user uses a sliding-type mobile device with a supplemental display screen, only a simple sliding operation is required to accomplish the operations of paging, entering function menus, browsing information, or the like. Consequently, time is saved and convenience is gained.

### PRIORITY

This application claims the benefit under 35 U.S.C. §119(a) of a Chinese patent application filed in the State Intellectual Property Office of the People's Republic of China on Feb. 25, 2007 and assigned Serial No. 200710080280.1, the entire disclosure of which is hereby incorporated by reference

### BACKGROUND OF THE INVENTION

1. Field of the Invention

The present invention relates to a sliding-type mobile device. More particularly, the present invention relates to a sliding-type mobile device with a supplemental display screen, which enables a user to browse a user interface (UI) with an extended display area.

2. Background of the Invention

An increasing number of functions are being integrated into mobile devices as they evolve. As a result of the increase in the number of functions, there is a corresponding increase in the amount of content that needs to be displayed on a user interface. However, problems have been encountered when displaying the increased amount of content. For example, in order to display a function list that includes numerous functions, multiple pages may be required. If a user wants to use a function listed at the bottom of the list, the user has to repeatedly press the UP and DOWN direction keys or scroll using a scroll bar to turn the pages in order to select the function. With respect to a touch screen-type mobile device, when a user repeatedly taps a scroll bar to select a function, mistakes will often occur in the selection due to the likelihood of the tap occurring on an incorrect position. With respect to a conventional keypad-type mobile device, the user also needs to press the keys several times to select a function, which is rather inconvenient. Furthermore, a function menu is often provided with a list of sub-menus. In this case, a user has to repeatedly enter and exit sub-menus to select a function, which will also cause inconvenience. In addition, when a user views an item with a large amount of information, such as an email, an internet page, a file, or an e-book, it would be convenient for the user if an additional amount of content could be displayed at one time.

Conventional solutions attempt to overcome the problem by redesigning the UI. For example, through research it has been determined that the operations of a mobile device can be simplified by arranging the functions that are most frequently used at a front position. However, as mobile devices provide more and more functions, the functions that are used most frequently significantly vary on an individual basis since each person has different habits and requirements. Accordingly, the existing solutions which consider only the majority of users can not ensure that a UI would be suitable for all users.

Therefore, a touch screen-type mobile device should be more advantageous. That is, a user should be able to access a function by tapping an icon representing the function with a finger or a touch pen, without having to locate the function by repeatedly pressing direction keys and a confirmation key. However, for a longer function list or for viewing content with a large amount of information, a touch screen-type mobile device can only provide direction soft-keys or scroll bars. When a user repeatedly drags a scroll bar to select a function, mistakes are often made in the selection due to the user's taps occurring on the wrong positions. Additionally, for a multi-level function list, a user has to repeatedly perform operations of entering and exiting lists even if he uses a touch screen-type mobile device. In this case, when compared with a mobile device with a physical keypad, touch screen-type mobile devices present no obvious advantage.

Therefore, a need exists for an improved mobile device capable of displaying more content and reducing the number of pages on which information is presented. However, considering the diversity and complication of functions included in mobile devices, a user's requirement for portability limits the ability of using a larger display screen.

### SUMMARY OF THE INVENTION

An aspect of the present invention is to address at least the above-mentioned problems and/or disadvantages and to provide at least the advantages described below. Accordingly, an aspect of the present invention is to provide a sliding-type mobile device with a supplemental display screen, which enables a user to browse a user interface (UI) with an extended display area.

According to an aspect of the present invention a sliding-type mobile device is provided. The mobile device includes a base, a first display screen disposed on the base, a sliding section disposed above the base and mechanically coupled to the base such that the sliding section moves relative to the base, a second display screen disposed on the sliding section, a processor for controlling operations of the mobile device, and a controller for receiving data and at least one control signal from the processor, and for transmitting the received data to one of the first display screen and the second display screen according to information in at least one control signal.

According to another aspect of the present invention, a method for applying a parallel information mode in a sliding-type mobile device having a first display screen, a second display screen, a processor and a controller is provided. The method includes determining whether content displayed on the second display screen is less than the entire portion of the content, and operating the first display screen in the parallel information mode and displaying a remaining portion of the entire content, if it is determined that the content displayed on the second display screen is less than the entire portion of the content.

According to another aspect of the present invention, a method for applying a browser information mode in a sliding-type mobile device having a first display screen, a second display screen, a processor and a controller is provided. The method includes determining whether content displayed on the second display screen is high-level content, and operating the first display screen in the browser information mode and displaying in the first display screen lower-level content corresponding to the high-level content, if it is determined that the content displayed on the second display screen is high-level content.

According to another aspect of the present invention, a method for applying a keypad information mode in a sliding-type mobile device having a first display screen, a second display screen, a processor and a controller is provided. The method includes determining whether content displayed on the second display screen is an editing interface, and operating the first display screen in the keypad information mode and displaying information on a virtual keypad, if it is determined that the content displayed on the second display screen is the editing interface.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a front view of a sliding-type mobile device with a supplemental display screen according to an exemplary embodiment of the present invention;

FIG. 2 is a side view of the sliding-type mobile device shown in FIG. 1;

FIG. 3 is a functional diagram of a sliding-type mobile device with a supplemental display screen according to an exemplary embodiment of the present invention;

FIG. 4 is a view illustrating the mobile device when a sub-display screen operates in a parallel information mode according to an exemplary embodiment of the present invention;

FIG. 5 is a view illustrating the mobile device when the sub-display screen operates in a browser information mode according to an exemplary embodiment of the present invention;

FIG. 6 is a flowchart illustrating a method for applying the parallel information mode in a mobile device according to an exemplary embodiment of the present invention;

FIG. 7 is a flowchart illustrating a method for applying the browser information mode in a mobile device according to an exemplary embodiment of the present invention;

FIG. 8 is a flowchart illustrating a method for applying a keypad information mode in a mobile device according to an exemplary embodiment of the present invention; and

FIG. 9 is a flowchart illustrating a method for simultaneously applying the parallel information mode, the browser information mode and the keypad information mode in a mobile device according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

A conventional sliding-type mobile device has a structure in which an upper section is provided with a display screen and a lower section is provided with a keypad. The conventional sliding-type mobile device is operated by pressing keys on the keypad. In contrast, a conventional touch screen-type mobile device does not need a physical keypad, and only maintains a minimal number of physical keys for critical functions. Meanwhile, a visual display area of a conventional touch screen-type mobile device is typically larger than the visual display area of a conventional sliding-type mobile device with a keypad because the keypad may be substantially omitted, thereby increasing the available surface area that can be used for a display. Exemplary embodiments of the present invention provide a mobile device with a new structure for a sliding-type mobile device and a touch screen-type mobile device, i.e. a sliding-type mobile device with a supplemental display screen.

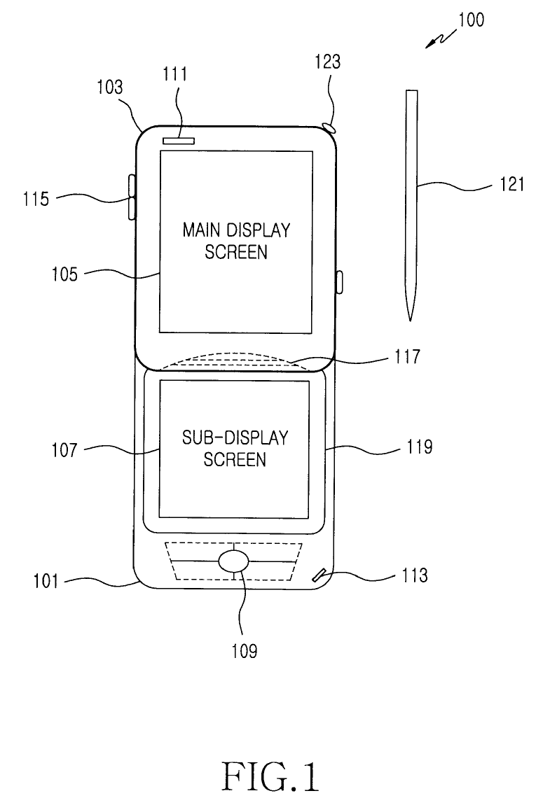

FIG. 1 is a front view of a sliding-type mobile device 100 with a supplemental display screen according to an exemplary embodiment of the present invention.

Referring to FIG. 1, the sliding-type mobile device 100 comprises a base 101 and a sliding section 103.

The base 101 includes a sub-display screen 107 and is provided with a function keypad 109 having one or more function keys. The sub-display screen 107 may be fixed on the base 101, or may be integrated with base 101. The inclusion of the function keypad 109 with base 101 is merely exemplary as function keypad 109 may be included with sliding section 103 or may be omitted.

The sliding section 103 includes a main display screen 105. The main display screen 105 may be fixed on the sliding section 103, or may be integrated with the sliding section 103. The main display screen 105 and the sub-display screen 107 may be touch screens, and have the same structures and functions as those of a conventional touch screen on a conventional touch screen-type mobile device.

The sliding section 103 is disposed above the base 101, and is connected to the base 101 in a sliding manner. The sliding section 103 can be slid back and forth with respect to the base 101.

Additionally, the mobile device 100 may include structures or components that are typically included in a conventional mobile device, such as a speaker 111, a microphone 113 and commonly used function keys such as a volume-adjusting key 115. The mobile device 100 may further include structures or components typically included in a conventional sliding-type mobile device, such as an anti-skid groove 117 for use when pushing open the sliding cover and a sliding slot 119. The mobile device 100 may also include structures or components typically included in a conventional touch screen-type mobile device, such as a touch pen 121 and a receptacle 123 for storing the touch pen 121. In the present specification, descriptions of the above well-known structures or components are omitted for clarity and conciseness.

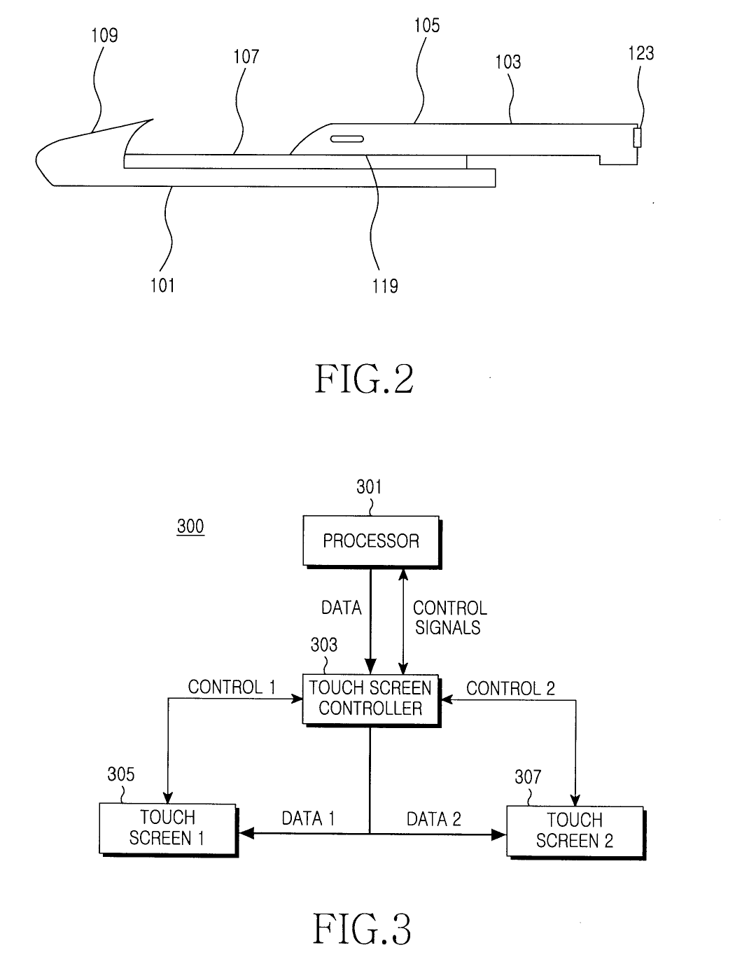

FIG. 2 is a side view of the sliding-type mobile device 100 shown in FIG. 1.

Referring to FIG. 2, the structure of the sliding-type mobile device 100 will be further described below. When a user pushes the sliding section 103 outwards, the display area of the sub-display screen 107 is exposed. That is to say, when sliding section 103 is slid away from base 101, the user can view the main display screen 105 and the sub-display screen 107 at the same time.

FIG. 3 is a functional diagram of a sliding-type mobile device 300 with a supplemental display screen according to an exemplary embodiment of the present invention.

Referring to FIG. 3, the sliding-type mobile device 300 comprises a processor 301, a touch screen controller 303, a first touch screen 305 and a second touch screen 307.

The processor 301 is similar to a processor in a conventional mobile device, and is used to control overall operations of the mobile device 300. The processor 301 may be embodied as an embedded CPU.

The touch screen controller 303 receives data and control signals from the processor 301, and determines to which display screen the touch screen controller 303 will transmit display information, according to information in the control signals. The touch screen controller 303 transmits data and control signals to the first touch screen 305 and the second touch screen 307. The touch screen controller 303 may be embodied as a Field Programmable Gate Array (FPGA) or Application Specific Integrated Circuit (ASIC).

In a conventional touch screen-type mobile device with a single touch screen, a processor can directly transmit data and control signals to a single touch screen. However, in a sliding-type mobile device according to exemplary embodiments of the present invention, two touch screens are provided. Therefore, the touch screen controller 303 provides an interface between the processor 301 and each touch screen 305 and 307.

One of the first touch screen 305 and the second touch screen 307 may serve as the main display screen 105, and the other one as the sub-display screen 107.

In exemplary embodiments of the present invention, the sub-display screen 107 can display information of different modes according to different situations. That is, the sub-display screen 107 can operate in different modes. For example, the operation modes of the sub-display screen 107 may include a parallel information mode, a browser information mode and a keypad information mode. A description of these modes is described below.

PARALLEL INFORMATION MODE: information displayed on the sub-display screen 107 serves as an extension of what is displayed on the main display screen 105, and levels of the information displayed on the sub-display screen 107 are the same as those of information displayed on the main display screen 105. For example, when a function list is too long to be completely displayed on the main display screen 105, a remaining portion of the function list can be displayed on the sub-display screen 107. The parallel information mode is also applicable to a situation where a user can see the remaining information that is not displayed on the main display screen by the sub-display screen when he reads multi-page short messages, emails, internet pages or e-books.

BROWSER INFORMATION MODE: information displayed on the sub-display screen 107 is an interpretation and an expansion of what is displayed on the main display screen 105. For example, in a case where a multi-level menu exists, when the main display screen 105 displays a first-level menu, a user can see a second-level menu corresponding to a function module where the cursor is located on the main display screen 105. The browser information mode is also applicable to the checking of correspondent-related information and the browsing of pictures and videos. When checking the correspondent-related information, the sub-display screen 107 displays all of the communications of a correspondent that is specified on the main display screen 105. When browsing pictures or videos, a picture corresponding to an index specified on the main display screen 105 can be viewed on the sub-display screen 107.

KEYPAD INFORMATION MODE: in a standby interface, an information-writing interface or other interfaces for editing, the sub-display screen 107 displays a virtual keypad with variable visual formats for the user's convenience. For example, in an information-writing interface, the sub-display screen 107 displays one of various user selectable character, numeric or alphanumeric keypads if a user selects a keypad input method, and the sub-display screen displays a keypad with stroke-related information if the user selects a handwriting recognition input method.

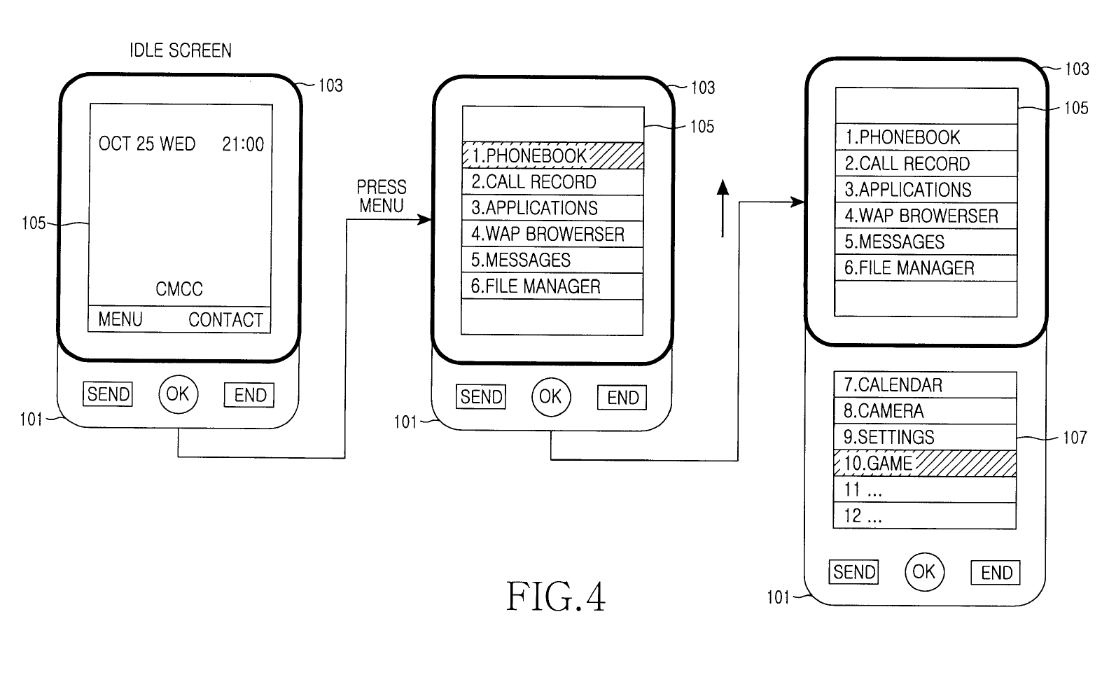

Hereinafter, the parallel information mode and the browser information mode of the sub-display screen 107 will be further described with reference to FIGS. 3 and 4.

FIG. 4 is a view illustrating the mobile device when the sub-display screen 107 operates in the parallel information mode according to an exemplary embodiment of the present invention.

Referring to FIG. 4, an idle screen is first displayed on the main display screen 105. When a MENU soft-key, displayed in the idle screen, is pressed by a user, a function list is then displayed on the main display screen 105. Because of its size, the main display screen 105 can only display 6 items as illustrated. At this time, the remaining items in the function list can be displayed on the sub-display screen 107 once the sliding section 103 is slid relative to the base 101.

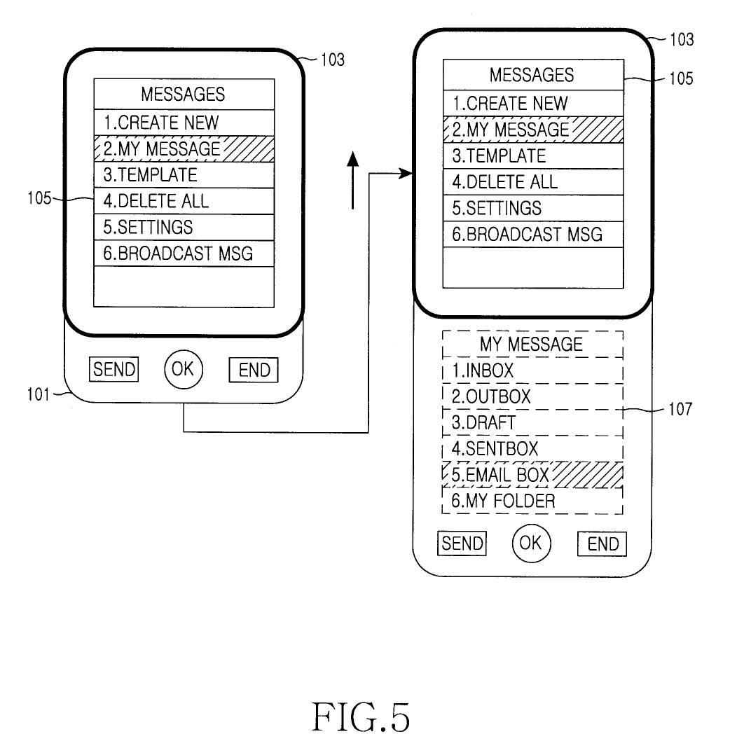

FIG. 5 is a view illustrating the mobile device when the sub-display screen 107 operates in a browser information mode according to an exemplary embodiment of the present invention.

Referring to FIG. 5, when the cursor is located on item “2. My message”, sub-items or sub-menus associated with item “2. My message” can be displayed on the sub-display screen 107. For example, sub-items or sub-menus such as “1. Inbox,” “2. Outbox” and the like may be displayed on sub-display 107. When the sub-items and/or sub-menus are so displayed on the sub-display screen 107, a user may execute one of the sub-items and/or sub-menus when the cursor is located on a desired function. For example, a user may execute a function of “5. Email Box” by either tapping on the touch screen or selecting the function with direction keys.

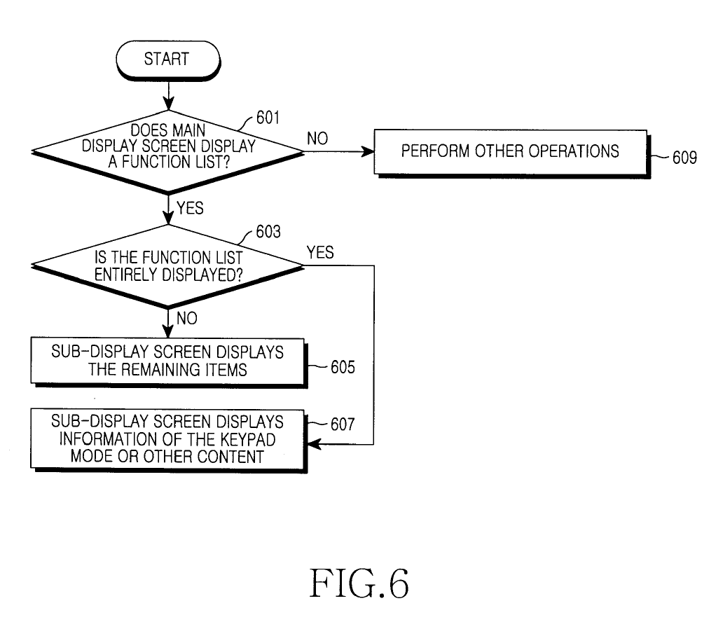

Hereinafter, methods for applying the above three operation modes of the sub-display screen 107 in a mobile device will be described with reference to FIGS. 6-8, respectively.

FIG. 6 is a flowchart illustrating a method for applying the parallel information mode in a mobile device according to an exemplary embodiment of the present invention.

In FIG. 6, a function list is taken as an example, and it is assumed that the sliding section has been pushed outwards, thereby exposing sub-display screen 107.

As shown in FIG. 6, in operation 601, the processor 301 determines whether the main display screen 105 is displaying a function list. If the main display screen 105 does not display a function list, the processor 301 performs other corresponding operations in operation 609.

If the main display screen 105 displays a function list, the processor 301 determines whether the function list is completely displayed on the main display screen 105 in operation 603. If the function list has been completely displayed on the main display screen 105, the processor 301 controls the sub-display screen 107 to display information of the keypad mode or other content in operation 607. If the function list is not completely displayed on the main display screen 105, the processor 301 will determine that the sub-display screen 107 should operate in the parallel information mode. Accordingly, in operation 605, the processor 301 transmits data regarding the remaining items of the function list to the sub-display screen 107 via the touch screen controller 303 so that the sub-display screen 107 displays the remaining items.

Though only a function list is described as an example, the process shown in FIG. 6 is also applicable to the browsing of the multi-page short messages, emails, internet pages, e-books and the like.

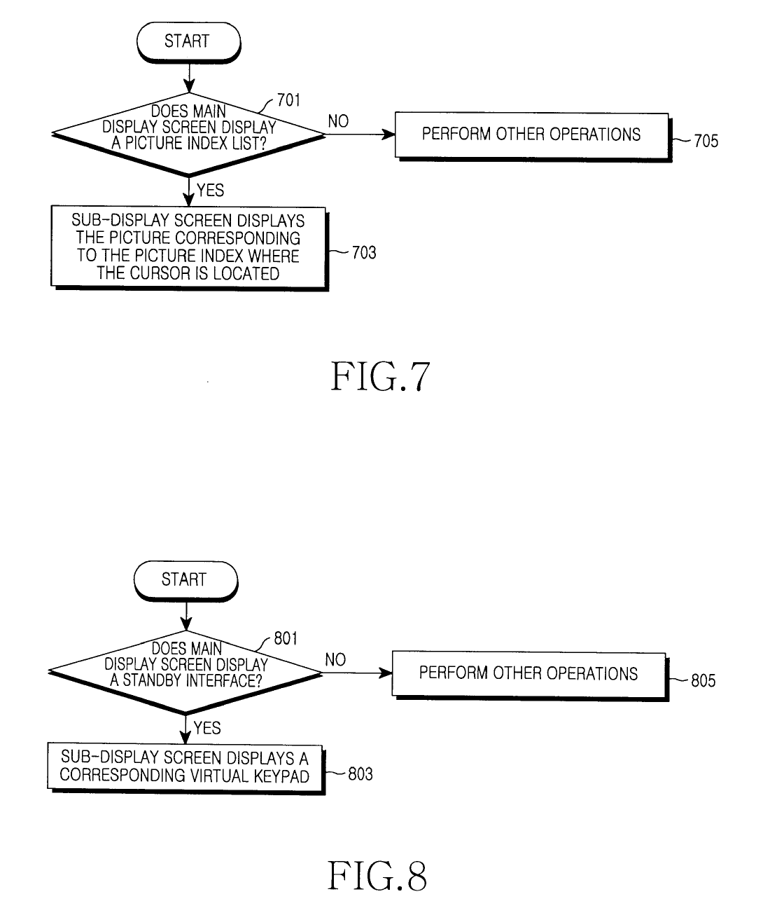

FIG. 7 is a flowchart illustrating a method for applying the browser information mode in a mobile device according to an exemplary embodiment of the present invention.

In FIG. 7, a picture index list is taken as an example, and it is assumed that the main display screen 105 has been pushed outwards and that the picture index list is fully displayed on the main display screen 105.

Referring to FIG. 7, in operation 701, the processor 301 determines whether the main display screen 105 is displaying a picture index list. If the main display screen 105 does not display a picture index list, the processor 301 performs other corresponding operations in operation 705.

If the main display screen 105 displays a picture index list, the processor 301 determines that the sub-display screen 107 should operate in the browser information mode. Accordingly, in operation 703, the processor 301 transmits data of a picture, corresponding to the picture index where the cursor is located, to the sub-display screen 107 via the touch screen controller 303, so that the corresponding picture will be displayed on the sub-display screen 107.

Though only a picture index list is described as an example, the process shown in FIG. 7 is also applicable to music or video index lists, a telephone directory, a function list having sub-menus, etc.

In the description of FIG. 7, it is assumed that the picture index list is completely displayed on the main display screen 105. However, if the picture index list is not completely displayed on the main display screen 105, the following methods can be used: 1) the sub-display screen 107 operates in the parallel information mode, i.e. the sub-display screen 107 displays the remaining items in the picture index list; 2) the sub-display screen 107 operates in the browser information mode, i.e. the sub-display screen 107 displays a corresponding picture, and in this mode, a scroll bar is displayed/provided on the main display screen 105 to allow the user to see all the items in the picture index list. The first described method is substantially the same as the parallel information mode described in FIG. 6.

FIG. 8 is a flowchart illustrating a method for applying the keypad information mode in a mobile device according to an exemplary embodiment of the present invention.

In FIG. 8, a standby interface is taken as an example, and it is assumed that the main display screen 105 has been pushed outwards, thereby exposing sub-display screen 107.

Referring to FIG. 8, in operation 801, the processor 301 determines whether the main display screen 105 is displaying a standby interface. If the main display screen 105 does not display a standby interface, the processor 301 performs other corresponding operations in operation 805.

If the main display screen 105 displays a standby interface, the processor 301 determines that the sub-display screen 107 should operate in the keypad information mode. Accordingly, in operation 803, the processor 301 transmits data regarding a virtual keypad selected by the user to the sub-display screen 107 via the touch screen controller 303, so that the sub-display screen 107 displays the corresponding virtual keypad.

Though only a standby interface is described as an example, the process shown in FIG. 8 is also applicable to an information-writing interface or other editing interfaces, etc.

As described above, in a sliding-type mobile device with an extra display screen according to an exemplary embodiment of the present invention, the sub-display screen can operate in a parallel information mode, a browser information mode and a keypad information mode. According to the requirements in practice or at the discretion of the user, the mobile device according to an exemplary embodiment of the present invention may apply one of the above three modes, any two of the above three modes or all the three modes.

By way of example, a case where only one of the above three modes is applied to a mobile device is described below with reference to FIG. 6 through 8 and their corresponding descriptions.

In a case where any two of the above three modes are applied, if the applied two modes are the parallel information mode and the browser information mode, the methods 1) and 2) mentioned above in the description of FIG. 7 can be adopted in a case where information (for example, a function list) is not completely displayed on the main display screen 105 and the information includes sub-information (for example, sub-menus).

Hereinafter, a case where all the above three modes are applied to a mobile device is described below.

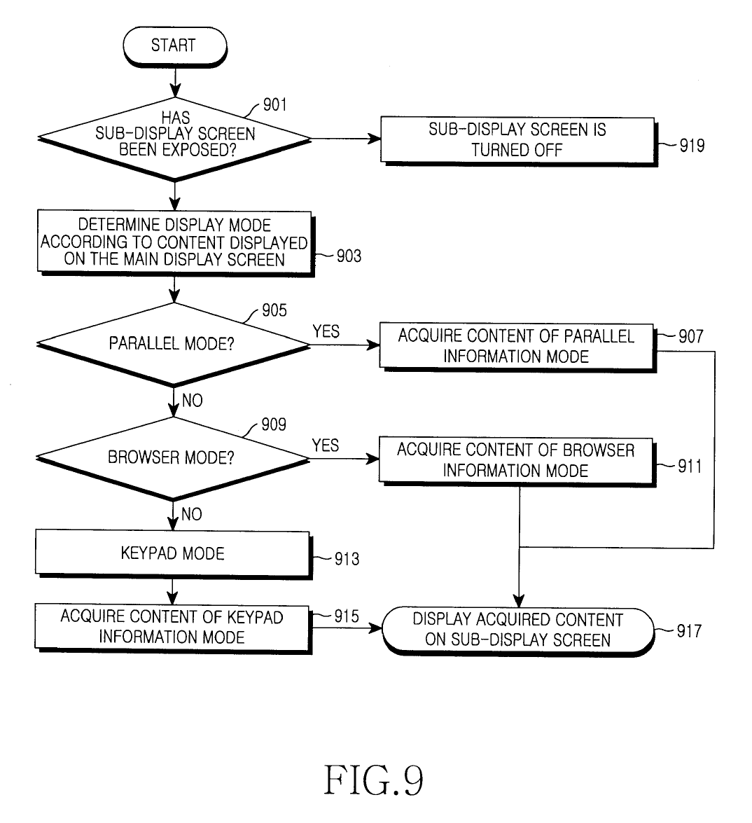

FIG. 9 is a flowchart illustrating a method for simultaneously applying the parallel information mode, the browser information mode and the keypad information mode in a mobile device according to an exemplary embodiment of the present invention.

Referring to FIG. 9, in operation 901, the processor 301 determines whether the main display screen 105 has been pushed outwards, thereby exposing sub-display screen 107. If the main display screen 105 has not been pushed outwards, the sub-display screen 107 is in a turned-off state in operation 919.

If the main display screen 105 has been pushed outwards, the processor 301 determines whether the sub-display screen 107 should operate in the parallel information mode, according to the content displayed on the main display screen 105, in operation 903. The detailed process of determining in operation 903 can be understood by referring to operations 601 and 603 of FIG. 6, operation 701 of FIG. 7 and operation 801 of FIG. 8.

If it is determined that the sub-display screen 107 should operate in the parallel information mode in operation 905, the sub-display screen 107 acquires the content of parallel information mode from the touch screen controller 303 in operation 907 and displays the acquired content in operation 917.

If it is determined that the sub-display screen 107 should not operate in the parallel information mode, the processor 301 determines whether the sub-display screen 107 should operate in the browser information mode in operation 909.

If it is determined that the sub-display screen 107 should operate in the browser information mode, the sub-display screen 107 acquires the content of browser information mode from the touch screen controller 303 in operation 911 and displays the acquired content in operation 917.

If it is determined that the sub-display screen 107 should not operate in the browser information mode, the processor 301 determines that the sub-display screen 107 should operate in the keypad information mode in operation 913. Accordingly, the sub-display screen 107 acquires the content of keypad information mode from the touch screen controller 303 in operation 915 and displays the acquired content in operation 917.

A sliding-type mobile device with a supplemental display screen as disclosed in the exemplary embodiments of the present invention may have a main display screen and a sub-display screen. In a case where the main display screen is not pushed outwards, the mobile device is capable of operating as a conventional touch screen-type mobile device with a single touch screen.

According to an exemplary embodiment of the present invention, while the portability of a mobile device is maintained, the touch screen-related technology and the sliding cover-related technology are fully applied for the convenience of user's operation of the mobile device. In a case where a user uses a sliding-type mobile device with a supplemental display screen according to an exemplary embodiment of the present invention, the user only needs a simple sliding operation to accomplish the operation of turning pages, entering a function menu, browsing information, etc, whereas with a conventional mobile device the user has to achieve the same by several key presses. Consequently, time is saved and convenience is gained. Also, the novel functions of the displays will bring an entirely new experience to a user.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A sliding-type mobile device comprising:
a base;
a first display screen disposed on the base;
a sliding section disposed above the base and mechanically coupled to the base such that the sliding section moves relative to the base;
a second display screen disposed on the sliding section;
a processor for controlling operations of the mobile device; and
a controller for receiving data and at least one control signal from the processor, and for transmitting the received data to one of the first display screen and the second display screen according to information in the at least one control signal.

2. The sliding-type mobile device according to claim 1, wherein the first display screen operates in at least one of a parallel information mode, a browser information mode and a keypad information mode according to content displayed on the second display screen.

3. The sliding-type mobile device according to claim 2, wherein when the content displayed on the second display screen is less than an entire portion of the content, the first display screen operates in the parallel information mode and displays a remaining portion of the content.

4. The sliding-type mobile device according to claim 3, wherein the content comprises at least one of a function list, a short message, an email, an internet page and an e-book.

5. The sliding-type mobile device according to claim 2, wherein when the content displayed on the second display screen comprises a high-level content, the first-display screen operates in the browser information mode and displays lower-level content of the high-level content.

6. The sliding-type mobile device according to claim 5, wherein the high-level content comprises at least one of a picture index list, a music index list, a video index list and a telephone directory.

7. The sliding-type mobile device according to claim 2, wherein when the content displayed on the second display screen comprises an editing interface, the first display screen operates in the keypad information mode and displays information on a virtual keypad.

8. The sliding-type mobile device according to claim 7, wherein the virtual keypad comprises one of a plurality of keypads selected by the user.

9. The sliding-type mobile device according to claim 7, wherein the editing interface comprises at least one of a standby interface and an information-writing interface.

10. A method for applying a parallel information mode in a sliding-type mobile device comprising a first display screen, a second display screen, a processor and a controller, the method comprising:
determining whether content displayed on the second display screen is less than the entire portion of the content; and
operating the first display screen in the parallel information mode and displaying a remaining portion of the entire content, if it is determined that the content displayed on the second display screen is less than the entire portion of the content.

11. The method according to claim 10, further comprising:
before the step of determining whether the content displayed on the second display screen is less than the entire content, determining whether the first display screen is exposed; and
operating the mobile device without the first display screen, if the first display screen is not exposed.

12. The method according to claim 11, wherein the entire content comprises one of a function list a short message, an email, an internet page and an e-book.

13. The method according to claim 10, wherein the content comprises content of a same level.

14. A method for applying a browser information mode in a sliding-type mobile device comprising a first display screen, a second display screen, a processor and a controller, the method comprising:
determining whether content displayed on the second display screen comprises high-level content; and
operating the first display screen in the browser information mode and displaying in the first display screen lower-level content corresponding to the high-level content, if it is determined that the content displayed on the second display screen comprises high-level content.

15. The method according to claim 14, further comprising:
before the step of determining whether the content displayed on the second display screen comprises high-level content, determining whether the first display screen is exposed; and
operating the mobile device without the first display screen, if the first display screen has not been exposed.

16. The method according to claim 15, wherein the high-level content comprises at least one of a picture index list, a music index list, a video index list and a telephone directory.

17. A method for applying a keypad information mode in a sliding-type mobile device having a first display screen, a second display screen, a processor and a controller, the method comprising:
determining whether content displayed on the second display screen comprises an editing interface; and
operating the first display screen in the keypad information mode and displaying information on a virtual keypad, if it is determined that the content displayed on the second display screen comprises the editing interface.

18. The method according to claim 17, further comprising:
before the step of determining whether the content displayed on the second display screen comprises an editing interface, determining whether the first display screen is exposed; and
operating the mobile device without the first display, if the first display screen has not been exposed.

19. The method according to claim 18, wherein the editing interface comprises at least one of a standby interface and an information-writing interface.

20. The method according to claim 17, wherein the wherein the virtual keypad comprises at least one of a plurality of keypads selected by the user.
